(19) United States
(12) Patent Application Publication
(10) Pub. No.: US 2026/0193934 A1
(43) Pub. Date: Jul. 9, 2026

(54) APPARATUS AND SYSTEMS FOR MODULAR SHADES AND METHODS OF USE THEREOF

(71) Applicant: The Shadery, Inc.

(72) Inventor: Matthew Weiler, New York, NY (US)

(73) Assignee: The Shadery, Inc., (US)

(21) Appl. No.: 19/441,485

(22) Filed: Jan. 6, 2026

Related U.S. Application Data
(60) Provisional application No. 63/742,233, filed on Jan. 6, 2025.

(51) Int. Cl. E06B 9/322; E06B 9/262

(52) U.S. Cl. CPC E06B 9/322; E06B 9/262; E06B 2009/2622; E06B 2009/2625; E06B 2009/3225

(57) ABSTRACT

A modular window covering system includes a bracket configured to be mounted to at least one of a wall, a ceiling, and an interior surface of a window frame, the bracket comprising a plurality of mounting apertures. The modular window covering system further includes a motor reversibly coupled to the bracket and a telescoping rod reversibly coupled to the motor. The telescoping rod comprises a plurality of arms configured to extend and retract to adjust a length of the telescoping rod. One or more strip spools are disposed along the telescoping rod. The modular window covering system also includes a shade including one or more shade strips, wherein each of the one or more strip spools interfaces with at least one of the one or more shade strips to facilitate raising and lowering of the shade.

### CROSS-REFERENCE TO RELATED APPLICATIONS

This application claims priority to U.S. Application No. 63/742,233, titled APPARATUS AND SYSTEMS FOR MODULAR SHADES AND METHODS OF USE THEREOF, filed January 6, 2025, which is hereby incorporated by reference in its entirety.

### FIELD OF THE PRESENT DISCLOSURE

The present disclosure relates to window covering systems, and more particularly to modular shade apparatuses and systems featuring telescoping rods, interchangeable textile fabrics, and motorized operation for improved ease of installation and customizability.

### BACKGROUND

Window shades have served as a fundamental element of interior design and home functionality for centuries, evolving from simple fabric coverings to sophisticated window treatment systems. Modern window shades are available in numerous configurations, including roller shades, cellular shades, and Roman shades, each offering different aesthetic and functional characteristics. Roman shades, in particular, have gained popularity due to their ability to provide substantial insulation properties owing to the thickness of the fabric materials employed, which can contribute to improved energy efficiency within residential and commercial spaces. Additionally, Roman shades support a wider range of fabric weights and premium materials compared to roller shades or blinds, and produce a more refined, elegant motion during operation.

Contemporary window shade systems have incorporated various technological advancements, including motorized operation and integration with home automation platforms. These motorized systems allow users to raise and lower shades remotely through dedicated controllers or smart home ecosystems, providing convenience and enabling programmable schedules for light management and privacy control. The integration of motors into shade assemblies has expanded the functionality of window treatments beyond their traditional manual operation.

Despite these advancements, existing window shade systems present several challenges related to installation, customization, and cost. Many conventional shade systems are manufactured as integrated units where the mounting hardware, drive mechanisms, and fabric components are permanently assembled together. This integrated construction approach can limit the ability of users to replace individual components, such as stained or damaged fabric panels, without replacing the entire shade assembly. Additionally, conventional shade systems are often designed for specific window dimensions, requiring custom manufacturing for non-standard window sizes, which can increase costs and lead times.

Installation of existing motorized shade systems can present difficulties for consumers seeking do-it-yourself solutions. Many systems require professional installation due to complex mounting procedures, electrical connections, or calibration requirements. Furthermore, the cost of motorized shade systems, particularly those compatible with smart home platforms, can be prohibitive for budget-conscious consumers seeking to upgrade their window treatments.

The ability to accommodate varying window widths within a single product configuration remains a challenge in the window shade industry. Conventional approaches often require consumers to select from predetermined size options or order custom-sized products, limiting flexibility and increasing inventory complexity for retailers and manufacturers alike. Even nominally standard windows often require custom-fitted shades due to installation tolerances and construction variability, with dimensional variations often requiring precision to approximately one-eighth of an inch.

In view of these considerations, there exists an opportunity for window shade systems that offer improved modularity, simplified installation procedures, and enhanced customization options while maintaining compatibility with motorized operation and smart home integration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an aspect of the present disclosure, a modular window covering system may be provided. The modular window covering system may include a bracket configured to be mounted to at least one of a wall, a ceiling, and an interior surface of a window frame. The bracket may comprise a plurality of mounting apertures. The modular window covering system may further comprise a motor reversibly coupled to the bracket. The modular window covering system may also include a telescoping rod reversibly coupled to the motor. The telescoping rod may comprise a plurality of arms configured to extend and retract to adjust a length of the telescoping rod. In an embodiment, modular window covering system may further comprise one or more strip spools disposed along the telescoping rod. The modular window covering system may additionally feature a shade including one or more shade strips. Each of the one or more strip spools may interface with at least one of the one or more shade strips to facilitate raising and lowering of the shade.

According to other aspects of the present disclosure, the modular window covering system may include one or more of the following features. Each of the one or more strip spools may comprise an insertion clip and a static clip connected via a clip joint. The insertion clip and the static clip may be configured such that the insertion clip exhibits a force toward the telescoping rod to pinch at least one of the one or more shade strips in place. The bracket may comprise a top mounting surface, a side mounting surface extending from the top mounting surface, and a plurality of motor mounting points disposed at each end of the bracket. The motor mounting points may be configured to facilitate coupling of the motor to the bracket. The plurality of arms may comprise a right arm and a left arm, wherein the right arm and the left arm are extendable to adjust the length of the telescoping rod. The telescoping rod may further comprise a first end disposed on the right arm and a second end disposed on the left arm, the first end and the second end configured to be positioned within a window frame with clearance on either side. The shade may further comprise a valence configured to cover the bracket, the telescoping rod, and the motor when the shade is installed, and a shade bottom defined by excess fabric folded upon itself to form an internal chamber. The valence may be reversibly coupled to the bracket via one or more magnets disposed within the valence. The motor may be configured to impart rotational motion upon the telescoping rod about a longitudinal axis of the telescoping rod to transition the shade between a fully drawn position, a partially drawn position, and an undrawn position.

According to another aspect of the present disclosure, a modular window covering system may be provided. The modular window covering system may feature a bracket comprising a top mounting surface and a side mounting surface. Further, the bracket may comprise a plurality of mounting apertures disposed upon at least one of the top mounting surface and the side mounting surface. The modular window covering system may also include a telescoping rod coupled to the bracket. In an embodiment, the telescoping rod may comprise a first arm and a second arm, wherein the first arm and the second arm are extendable to adjust a length of the telescoping rod. Moreover, the modular window covering system may include a motor coupled to the telescoping rod and configured to impart rotational motion upon the telescoping rod. Yet further, the modular window covering system may additionally feature a shade reversibly coupled to the telescoping rod. The shade may be interchangeable without removal of the bracket.

According to other aspects of the present disclosure, the modular window covering system may include one or more of the following features. The modular window covering system may further comprise a plurality of strip spools disposed along the telescoping rod, each of the plurality of strip spools configured to interface with a shade strip extending to the shade. Each of the plurality of strip spools may comprise an insertion clip and a static clip connected via a clip joint, the insertion clip and the static clip configured such that the insertion clip exhibits a force toward the telescoping rod to pinch the shade strip in place. The bracket may further comprise a plurality of motor mounting points disposed at each end of the bracket, the motor mounting points configured to facilitate coupling of the motor to the bracket. The shade may comprise a valence configured to cover the bracket, the telescoping rod, and the motor when the shade is installed, the valence reversibly coupled to the bracket.

According to yet another aspect of the present disclosure, a method of installing a modular window covering system may be provided. The method may comprise mounting a bracket to at least one of a wall, a ceiling, and an interior surface of a window frame via a plurality of mounting apertures disposed on the bracket. Furthermore, the method may include coupling a motor to the bracket. Additionally, the method may also comprise coupling a telescoping rod to the motor, the telescoping rod comprising a plurality of arms. The method may additionally comprise adjusting a length of the telescoping rod by extending or retracting at least one of the plurality of arms until the telescoping rod is sized to fit within a window opening with clearance on either side. In an embodiment, the method may further comprise reversibly coupling a shade to the telescoping rod, wherein the shade may comprise one or more textile fabrics that are interchangeable without removal of the bracket.

According to other aspects of the present disclosure, the method may include one or more of the following features. Reversibly coupling the shade to the telescoping rod may comprise interfacing a plurality of strip spools disposed along the telescoping rod with a plurality of shade strips affixed to the shade to facilitate raising and lowering of the shade. Each of the plurality of strip spools may comprise an insertion clip and a static clip connected via a clip joint, and interfacing the plurality of strip spools may comprise positioning at least one of the plurality of strip spools such that the insertion clip exhibits a force toward the telescoping rod to pinch the at least one of the plurality of shade strips in place. The method may further comprise coupling a valence to the bracket to cover the bracket, the telescoping rod, and the motor, wherein the valence is reversibly coupled to the bracket via one or more magnets disposed within the valence.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1A illustrates an isometric view of a modular shade system, according to aspects of the present disclosure.

FIG. 1B illustrates an isometric view of a modular shade system, according to aspects of the present disclosure.

FIG. 2A illustrates an isometric view of a bracket for the modular shade system of FIG. 1A, according to aspects of the present disclosure.

FIG. 2B illustrates an isometric view of a bracket for the modular shade system of FIG. 1B, according to aspects of the present disclosure.

FIG. 3 illustrates an orthogonal view of a telescoping rod and motor assembly, according to aspects of the present disclosure.

FIG. 4 illustrates an isometric view of a shade for use with a modular shade system, according to aspects of the present disclosure.

FIG. 5 illustrates an isometric view of the telescoping rod and motor assembly of FIG. 3 in a partially extended configuration, according to aspects of the present disclosure.

FIG. 6 illustrates an isometric view of a strip spool assembly, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Disclosed herein are apparatuses and systems for modular window coverings and methods of use thereof. A modular window covering system may offer improved ease of use for users. For example, a modular window covering system may fit within a variety of windows. That is, a modular window covering system may be sized to fit within a plurality of window sizes without requiring custom manufacturing or replacement of structural components.

A modular window covering system may improve user customizability. To illustrate, a modular window covering system may enable one or more textile fabrics to be easily interchanged within the system. The modularity of the system may allow users to replace fabric portions of shades without having to replace the entirety of the system. For instance, if a textile fabric becomes stained or a user desires a different aesthetic, the textile fabric may be removed and replaced while the remaining structural components of the system remain in place. This modular approach may reduce costs associated with window covering maintenance and customization.

A modular window covering system may accommodate various window sizes through adjustable components. The adjustable sizing capability may eliminate the need for costly custom-made window coverings while still providing a tailored fit for non-standard window dimensions. A modular window covering system may provide a do-it-yourself solution where users may purchase a single product configuration and adjust the system to fit their specific window dimensions during installation.

A modular window covering system may be formed from a rigid material. In some cases, the rigid material may include acrylonitrile butadiene styrene (ABS), aluminum, polyvinyl chloride (PVC), steel, wood, or a combination thereof. However, a modular window covering system may be formed from any suitable rigid material alternative that provides structural support for the window covering components.

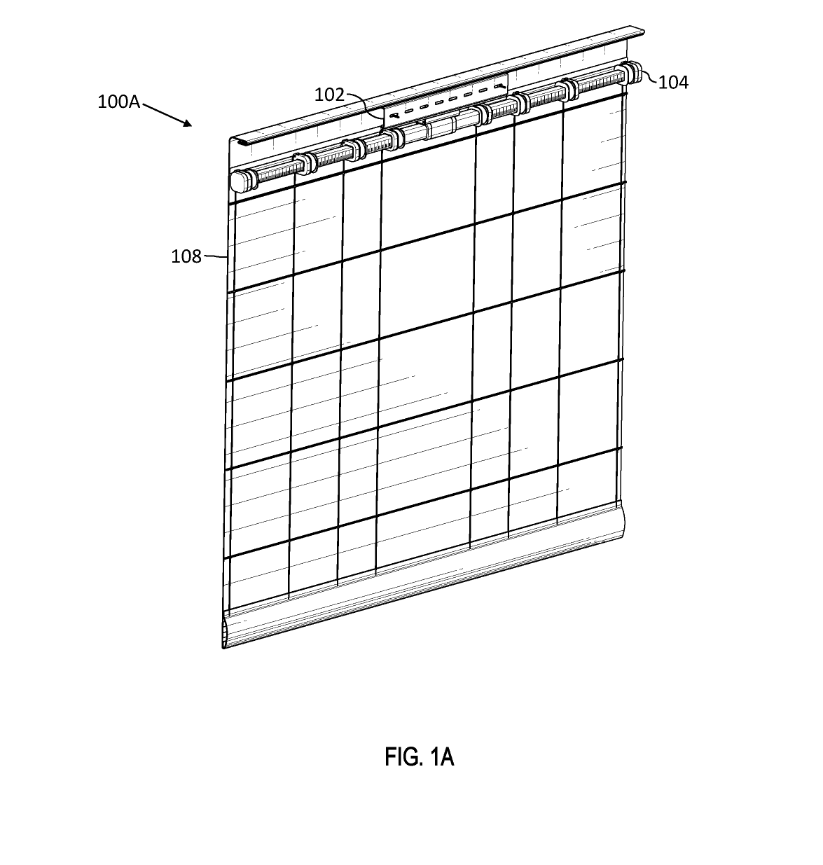

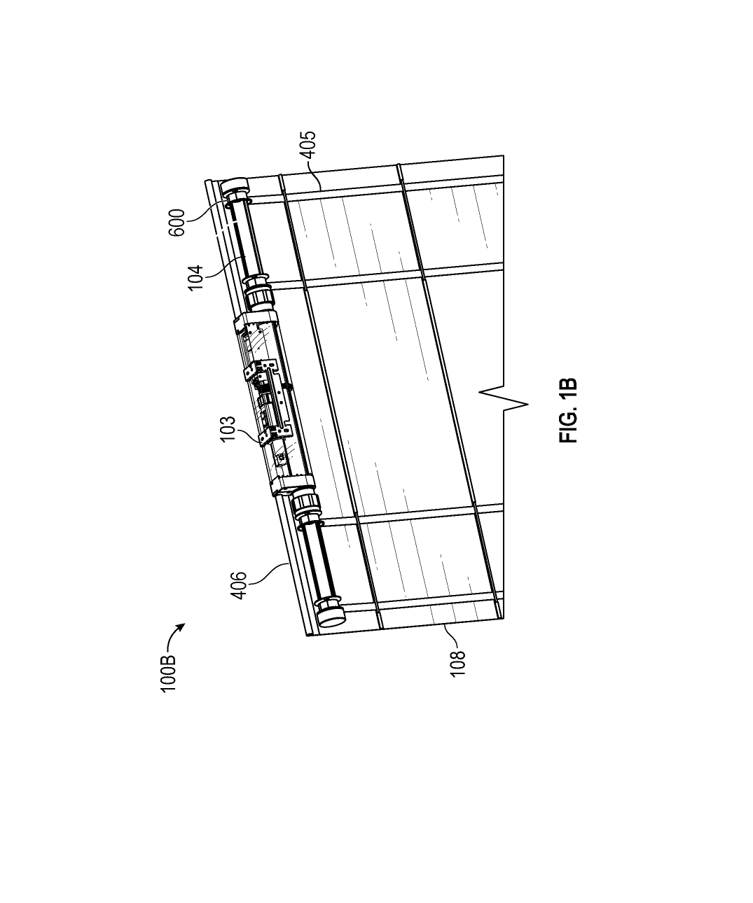

Referring to FIG. 1A, an alternate modular shade system 100A is illustrated. Such a modular shade system 100A may comprise an alternate bracket 102, a telescoping rod 104, and a shade 108. The bracket 102 may be positioned at an upper portion of the modular shade system 100A and may provide a mounting structure for securing the modular shade system 100A to a wall, a ceiling, or an interior surface of a window frame such as a head jamb. The bracket 102 may be configured to be mounted to at least one of a wall, a ceiling, and an interior surface of a window frame to support the remaining components of the modular shade system 100A.

The telescoping rod 104 may be coupled to the bracket 102 and may extend horizontally across a width of the modular shade system 100A. In some cases, the telescoping rod 104 may be reversibly coupled to a motor, and the motor may be reversibly coupled to the alternate bracket 102. The telescoping rod 104 may include multiple segments that allow for adjustment to accommodate various window sizes. The adjustable configuration of the telescoping rod 104 may enable the modular shade system 100A to fit within windows of different widths without requiring custom manufacturing.

With continued reference to FIG. 1A, the shade 108 may be reversibly coupled to the telescoping rod 104 via a plurality of attachment members. The shade 108 may extend downward from the telescoping rod 104 and may include a grid pattern formed by support wires and textile fabric sections arranged in a Roman shade configuration. The shade 108 may terminate at a bottom edge that provides weight and stability to the fabric assembly.

The reversible coupling between the shade 108 and the telescoping rod 104 may enable the shade 108 to be interchangeable without removal of the bracket 102. In some cases, the shade 108 may be interchangeable without removal of the bracket 102, as well as the telescoping rod 104 and/or the motor. This configuration may allow users to replace the shade 108 for aesthetic purposes or due to wear without disassembling the structural components of the modular shade system 100A. The bracket 102, the telescoping rod 104, and the shade 108 may work together to create an adjustable window covering solution that accommodates user customization and various window dimensions.

Referring to FIG. 1B, a modular shade system 100B is illustrated. The modular shade system 100B may comprise a bracket 103, the telescoping rod 104, a strip spool 600, one or more shade strips (alternatively, the “strip” or the “shade strip”) 405, a valence 406, and the shade 108. The modular shade system 100B may provide a different mounting configuration compared to the alternate modular shade system 100A while maintaining the modular and adjustable characteristics of the window covering system.

The bracket 103 may be positioned at an upper portion of the modular shade system 100B and may provide a mounting structure for securing the modular shade system 100B to a wall, a ceiling, or an interior surface of a window frame such as a head jamb. The bracket 103 may offer a different mounting configuration compared to the alternate bracket 102, which may accommodate different installation requirements or window frame configurations.

With continued reference to FIG. 1B, the telescoping rod 104 may be coupled to the bracket 103 and may extend horizontally across a width of the modular shade system 100B. The telescoping rod 104 may include multiple segments that allow for adjustment to accommodate various window sizes, similar to the configuration described with respect to the alternate modular shade system 100A.

The modular shade system 100B may include one or more strip spools 600 disposed along the telescoping rod 104. Each strip spool 600 may be configured to interface with at least one of the one or more shade strips 405 extending to the shade 108 to facilitate raising and lowering of the shade 108. For instance, the shade strip 405 may be affixed to the shade 108. Such a strip 405 may traverse a height of the shade 108 and may connect the shade 108 to the strip spool 600.

In some cases, the shade strip 405 may attach to a first horizontal structural rod positioned above a bottom weighted bar of the shade 108, rather than attaching directly to the bottom bar itself. As the telescoping rod 104 rotates, the strip spool 600 may wind or unwind the shade strip 405, causing the shade 108 to transition between raised and lowered positions. As a nonlimiting example, the shade strip 405 may be comprised of vinyl, cloth/fabric, plastic, chain/bead system, plastic or metal cord, magnetic system or any other flexible material suitable to be wound about the strip spool 600.

The shade 108 may be reversibly coupled to the telescoping rod 104 and may extend downward from the telescoping rod 104. The shade 108 may include horizontal support elements and textile fabric sections arranged in a Roman shade configuration. The shade strip 405 may be visible traversing the height of the shade 108, providing the mechanical connection between the shade 108 and the strip spool 600 that enables motorized operation of the shade 108. In some cases, the support wires 404 and shade strips 405 may serve as functionally equivalent alternatives for facilitating raising and lowering of the shade 108.

As further shown in FIG. 1B, the valence 406 may be positioned at an upper portion of the modular shade system 100B. The valence 406 may be configured to cover the bracket 103, the telescoping rod 104, and a motor when the shade 108 is installed. The valence 406 may conceal structural and mechanical components from view, providing a finished aesthetic appearance to the modular shade system 100B.

The shade 108 in the modular shade system 100B may be interchangeable without removal of the bracket 103. In some cases, the shade 108 may be interchangeable without removal of the telescoping rod 104 or the motor. This configuration may allow users to replace the shade 108 for aesthetic purposes or due to wear while the structural components of the modular shade system 100B remain in place. The modular design may reduce costs associated with window covering maintenance and customization by enabling replacement of the textile fabric portions without requiring replacement of the mechanical and structural components.

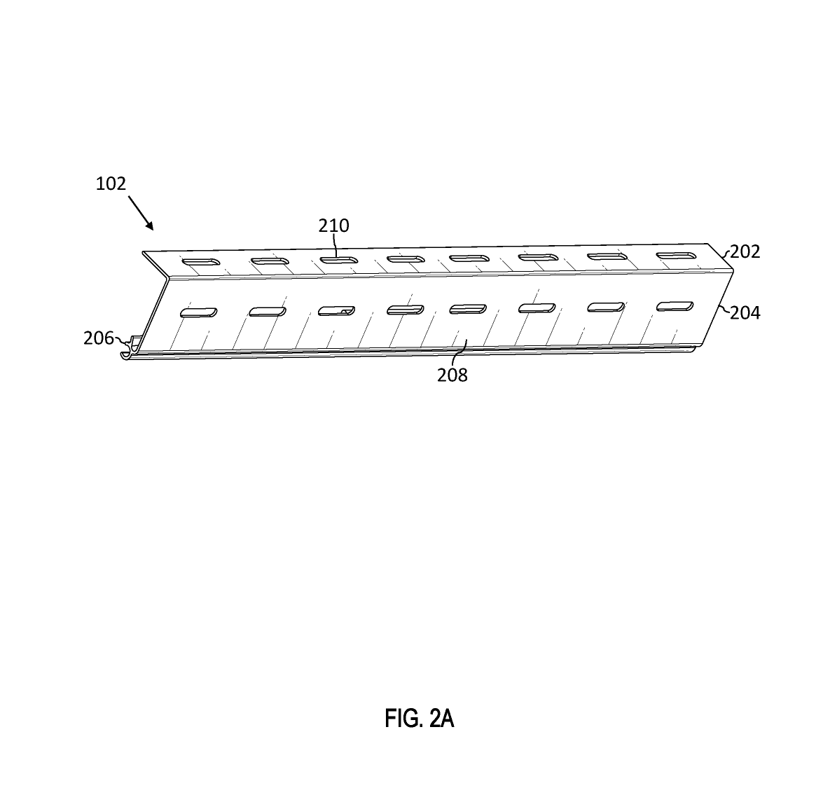

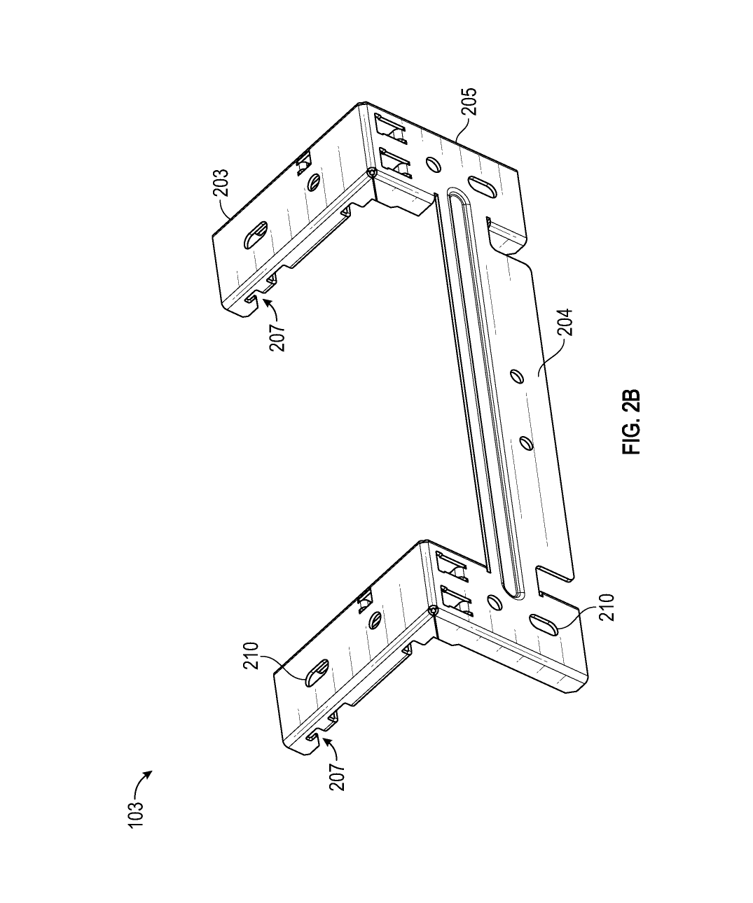

Referring to FIG. 2A, the bracket 102 is illustrated in greater detail. The alternate bracket 102 may comprise a top wall 202, a side wall 204, a rail 206, a bracket exterior 208, and a plurality of mounting apertures 210. The top wall 202 may be positioned orthogonal to the side wall 204, forming an L-shaped cross-sectional profile. The orthogonal relationship between the top wall 202 and the side wall 204 may provide structural rigidity to the alternate bracket 102 and may facilitate mounting of the alternate bracket 102 to different surfaces.

The top wall 202 and the rail 206 may be permanently affixed to the side wall 204. In some cases, the top wall 202 and the rail 206 may be disposed upon opposite sides of the side wall 204. The rail 206 may be disposed along a lower edge of the side wall 204 on an opposite side from the top wall 202. The rail 206 may extend along a length of the alternate bracket 102 and may provide an attachment point for coupling a motor to the alternate bracket 102. In some cases, a motor may be reversibly coupled to the alternate bracket 102 via a motor clip that interfaces with the rail 206. The motor clip may engage with the rail 206 to secure the motor to the alternate bracket 102 while allowing repositioning of the motor along the length of the alternate bracket 102.

With continued reference to FIG. 2A, the bracket exterior 208 may form an outer surface of the bracket 102 that interfaces with a mounting surface such as a wall, a ceiling, or an interior surface of a window frame. The alternate bracket 102 may be reversibly affixed to a wall or an interior surface of a window frame such that the bracket 102 is in at least one of an affixed state and an unaffixed state. While in the affixed state, the bracket exterior 208 may interface with the wall or interior surface such that the side wall 204 is flush with the mounting surface.

The plurality of mounting apertures 210 may be disposed upon at least one of the top wall 202 and the side wall 204. As shown in FIG. 2A, the plurality of mounting apertures 210 may appear as elongated slots arranged in a linear pattern along a length of the alternate bracket 102. The plurality of mounting apertures 210 may traverse the alternate bracket 102 such that the bracket exterior 208 is in fluid communication with a bracket interior. The elongated shape of the plurality of mounting apertures 210 may provide flexibility in positioning mounting fixtures during installation.

In a method of installing a modular window covering system, mounting the alternate bracket 102 to at least one of a wall, a ceiling, and an interior surface of a window frame may be performed via the plurality of mounting apertures 210 disposed on the alternate bracket 102. One or more mounting fixtures, such as screws or nails, may traverse one or more of the plurality of mounting apertures 210 to affix the alternate bracket 102 to the wall, the ceiling, or the interior surface of the window frame. In some cases, the one or more mounting fixtures may traverse one or more of the plurality of mounting apertures 210 disposed upon the side wall 204 such that when the alternate bracket 102 is in the affixed state, the side wall 204 is flush with the wall or interior surface. Alternatively, the one or more mounting fixtures may traverse one or more of the plurality of mounting apertures 210 disposed upon the top wall 202 such that when the alternate bracket 102 is in the affixed state, the top wall 202 is flush with a ceiling or a head jamb of a window frame.

The bracket 102 may be further comprised of a level disposed upon the bracket interior. The level may enable a user to determine whether the alternate bracket 102 is level when the user affixes the alternate bracket 102 to the wall. The level may assist in proper alignment of the alternate bracket 102 during installation to provide a visually appealing and functionally correct positioning of the modular shade system 100A.

Referring to FIG. 2B, the bracket 103 is illustrated in greater detail. The bracket 103 may comprise a top mounting surface 203, a side wall 204, a side mounting surface 205, a plurality of motor mounting points 207, and a plurality of mounting apertures 210. The bracket 103 may be configured as a U-shaped structure from a front view where the side wall 204 connects two side mounting surfaces 205. The bracket 103 may also exhibit an L-shaped cross-section between the top mounting surface 203 and the side mounting surface 205.

The top mounting surface 203 may be positioned at an upper portion of the bracket 103 and may extend horizontally from the side mounting surface 205. The side mounting surface 205 may be positioned at a lower portion of the bracket 103 and may extend vertically from the top mounting surface 203 in a direction parallel to the side wall 204. The side wall 204 may include a central elongated slot that traverses a portion of a length of the side wall 204.

With continued reference to FIG. 2B, the plurality of mounting apertures 210 may be disposed upon at least one of the top mounting surface 203 and the side mounting surface 205. The plurality of mounting apertures 210 may appear as elongated slots arranged along a length of each mounting surface. The plurality of mounting apertures 210 may allow mounting fixtures such as screws or nails to pass through and secure the bracket 103 to a wall or a ceiling surface. In a modular window covering system, the bracket 103 may comprise the top mounting surface 203 and the side mounting surface 205, with the plurality of mounting apertures 210 disposed upon at least one of the top mounting surface 203 and the side mounting surface 205.

The plurality of motor mounting points 207 may be disposed at each end of the bracket 103. As shown in FIG. 2B, the plurality of motor mounting points 207 may be hook shaped and may be positioned at an end of the top mounting surface 203 furthest from the side mounting surface 205. The plurality of motor mounting points 207 may include apertures and structural features that facilitate coupling of a motor to the bracket 103. The plurality of motor mounting points 207 may be configured to facilitate coupling of the motor to the bracket 103 by providing secure attachment locations at each end of the bracket 103. The shade 108 may be interchangeable without removal of the bracket 103.

The bracket 103 may comprise a structural bar that locks a fabric assembly into a console and serves as an attachment interface between a stationary portion of a fabric system and a drive assembly. The structural bar configuration of the bracket 103 may provide a mounting structure for securing the modular shade system 100B to a wall or a ceiling while offering a different mounting configuration compared to the bracket 102.

The modular shade system 100B may include a side fabric panel that functions as a decorative and concealing end cap. The side fabric panel may visually hide hardware from a side view and may interface with a wall or a window recess for a finished appearance. The side fabric panel may attach to the bracket 103 to provide aesthetic concealment of structural components. In some cases, the side fabric panel may have openings configured to ensure the same part is usable on both left and right hand sides. In other cases, updated side fabric panels may be unique to each side, with left hand and right hand versions configured for their respective positions within the modular shade system 100B.

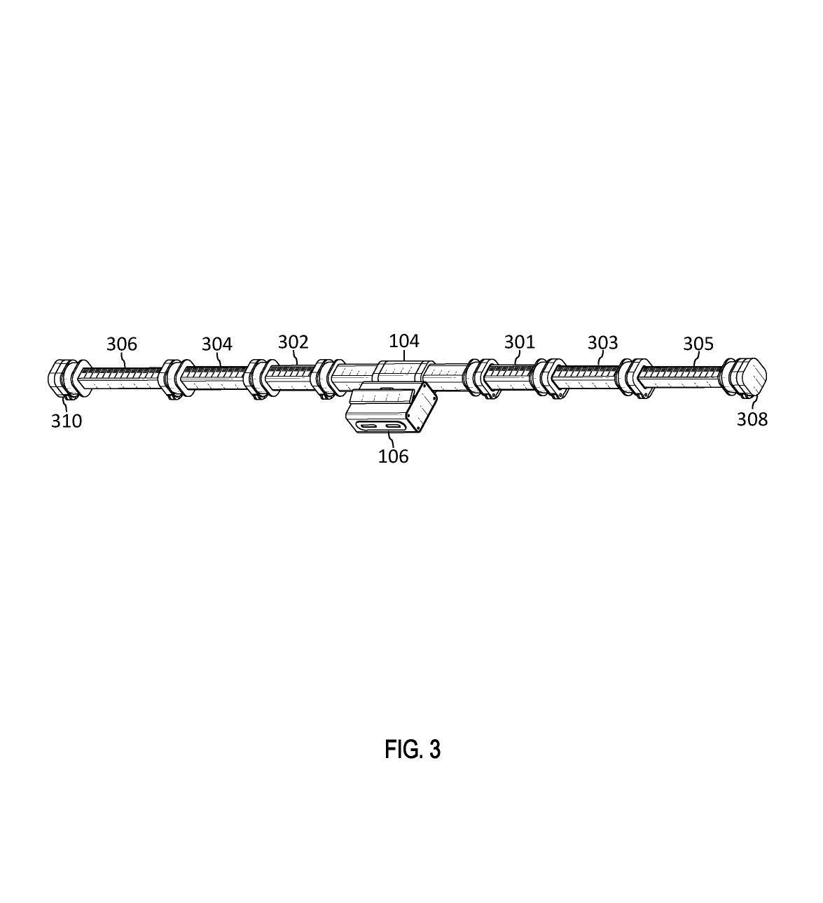

Referring to FIG. 3, the telescoping rod 104 and a motor 106 assembly is illustrated. The motor 106 may be positioned centrally along the telescoping rod 104 and may include a housing with visible connection ports on a lower surface thereof. The motor 106 may be reversibly coupled to the alternate bracket 102 or the bracket 103, and the telescoping rod 104 may be reversibly coupled to the motor 106. In a method of installing a modular window covering system, coupling the motor 106 to the alternate bracket 102 or the bracket 103 may be performed prior to coupling the telescoping rod 104 to the motor 106.

The motor 106 may be an AC induction motor. However, any suitable electric motor alternative may comprise the motor 106, including a brushed DC motor, a brushless DC motor, a synchronous motor, a servo motor, a stepper motor, or a torque motor. The motor 106 may be in electrical communication with a battery to provide the motor 106 with a supply of electricity. In some cases, the battery may be a replaceable lithium-ion battery.

With continued reference to FIG. 3, the motor 106 may include a rotating wheel that produces a rotational output. The rotating wheel may engage with the telescoping rod 104 to translate energy derived from the battery into rotational movement of the telescoping rod 104. The motor 106 may be configured to impart rotational motion upon the telescoping rod 104 about a longitudinal axis of the telescoping rod 104 to transition the shade 108 between a fully drawn position, a partially drawn position, and an undrawn position.

The telescoping rod 104 may be reversibly coupled to the motor 106 via one or more projections and one or more slots. The one or more projections may be disposed on the telescoping rod 104 and may be orthogonal to the telescoping rod 104, extending outwardly from the telescoping rod 104. The one or more slots may be disposed on the motor 106 and may be comprised of two cavities disposed within a surface of the motor 106 such that the one or more projections may be inserted into the one or more slots to facilitate reversible coupling of the telescoping rod 104 to the motor 106.

The motor 106 may be further comprised of a motor clip. The motor clip may be a projection disposed upon a back of the motor 106. The motor clip may be pivotably attached to the motor 106 such that the motor clip may move along a movement path while the motor 106 remains stationary. The motor clip may reversibly couple to the rail 206 of the alternate bracket 102 to facilitate reversible coupling of the motor 106 to the alternate bracket 102. When the motor 106 is affixed to the alternate bracket 102, the motor 106 may be repositioned along a length of the alternate bracket 102 via the motor clip.

As further shown in FIG. 3, the telescoping rod 104 may comprise a plurality of arms configured to extend and retract to adjust a length of the telescoping rod 104. The plurality of arms may be arranged symmetrically on either side of the motor 106. The plurality of arms may comprise a first left arm 302 and a first right arm 301 positioned adjacent to the motor 106. A second left arm 304 and a second right arm 303 may extend from the first left arm 302 and the first right arm 301, respectively. A third left arm 306 and a third right arm 305 may extend from the second left arm 304 and the second right arm 303, respectively, forming outermost segments of the telescoping rod 104.

The telescoping rod 104 may further comprise a first end 308 disposed on the third right arm 305 and a second end 310 disposed on the third left arm 306. The first end 308 and the second end 310 may feature tapered configurations. The first end 308 and the second end 310 may be configured to be positioned within a window frame with clearance on either side, such that the telescoping rod 104 may rotate freely without contacting the window frame.

In a method of installing a modular window covering system, adjusting a length of the telescoping rod 104 may be performed by extending or retracting the plurality of arms. The plurality of arms may be configured to slide relative to one another, allowing the telescoping rod 104 to transition between a collapsed configuration and a fully extended configuration.

The telescoping rod 104, while in the collapsed configuration, may have a length of twelve (12) inches, eighteen (18) inches, twenty-four (24) inches, thirty-six (36) inches, or any other length determined to useful or relevant based on either or both manufacturing needs and consumer needs. In the collapsed configuration, the first left arm 302, the first right arm 301, the second left arm 304, the second right arm 303, the third left arm 306, and the third right arm 305 may be fully retracted.

The telescoping rod 104, while in the fully extended configuration, may have a length of approximately fifty-seven (57) inches, sixty (60) inches, sixty-five (65) inches, seventy-two (72) inches, eighty (80) inches, or any other length determined to useful or relevant based on either or both manufacturing needs and consumer needs, wherein the first left arm 302, the first right arm 301, the second left arm 304, the second right arm 303, the third left arm 306, and the third right arm 305 are fully extended. The arms may extend symmetrically on each side of the motor 106. The above described ranges in collapsed and extended lengths are only provided as examples, and in some versions the telescoping rod 104 may collapse further or less, extend further or less, or may collapse or extend to any other length between or beyond the listed lengths.

The first left arm 302, the first right arm 301, the second left arm 304, the second right arm 303, the third left arm 306, and the third right arm 305 may include measurement markings along surfaces thereof. The measurement markings may enable a user to ascertain the length of the telescoping rod 104 during installation or adjustment. The positioning of the telescoping rod 104 in the collapsed configuration or the fully extended configuration may depend upon a size of the window in which the alternate modular shade system 100A or the modular shade system 100B is installed.

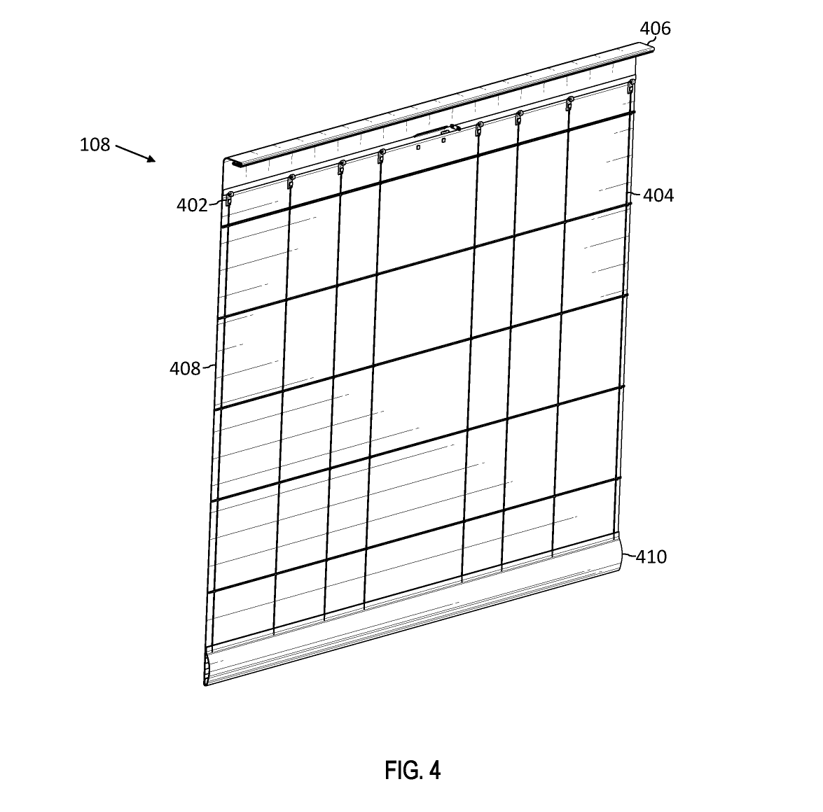

Referring to FIG. 4, the shade 108 is illustrated in greater detail. The shade 108 may comprise a plurality of attachment members 402, one or more support wires 404, the valence 406, one or more textile fabrics 408, and a shade bottom 410. The shade 108 may be reversibly coupled to the telescoping rod 104 via the plurality of attachment members 402. The reversible coupling between the shade 108 and the telescoping rod 104 may enable the shade 108 to be interchangeable without removal of the alternate bracket 102, the motor 106, or the telescoping rod 104.

The plurality of attachment members 402 may be disposed along an upper portion of the shade 108. The plurality of attachment members 402 may be positioned on an inside surface of the shade 108 such that the plurality of attachment members 402 are not visible from within a dwelling. The plurality of attachment members 402 may facilitate reversible coupling between the shade 108 and the telescoping rod 104. In some cases, the plurality of attachment members 402 may interface with a plurality of rod attachment clips disposed on the telescoping rod 104. The plurality of rod attachment clips may open to receive the plurality of attachment members 402 and subsequently close to secure the plurality of attachment members 402. This configuration may allow a user to freely interchange the shade 108 without removal of the alternate bracket 102. In some cases, the shade 108 may be interchanged while the telescoping rod 104 and the motor 106 remain as fixtures within the alternate modular shade system 100A or the modular shade system 100B.

With continued reference to FIG. 4, the one or more support wires 404 may extend vertically through the shade 108. The one or more support wires 404 may be affixed to the plurality of attachment members 402 at a terminal end of each support wire 404. The one or more support wires 404 may not be visible to users within a dwelling due to the positioning of the one or more support wires 404 on an interior side of the shade 108. The one or more support wires 404 may enable the shade 108 to transition between a fully drawn position, a partially drawn position, and an undrawn position. In the fully drawn position, the shade 108 may entirely block a window in which the shade 108 resides from a user’s view. In the partially drawn position, the shade 108 may block a portion of the window. In the undrawn position, the shade 108 may not block any portion of the window, allowing the user to see the entirety of the window.

The motor 106 may impart rotational motion upon the telescoping rod 104 about a longitudinal axis of the telescoping rod 104, enabling the shade 108 to transition freely between the fully drawn position and the undrawn position. The rotational motion imparted upon the telescoping rod 104 via the motor 106 may coil or uncoil the one or more support wires 404 about the plurality of rod attachment clips. The telescoping rod 104 rotating in a first direction may correspond to the one or more support wires 404 coiling about the plurality of rod attachment clips. The telescoping rod 104 rotating in a second direction may correspond to the one or more support wires 404 uncoiling from the plurality of rod attachment clips. As the one or more support wires 404 coil about the plurality of rod attachment clips, the shade 108 may transition from the fully drawn position to either the partially drawn position or the undrawn position. As the one or more support wires 404 uncoil from the plurality of rod attachment clips, the shade 108 may transition from either the partially drawn position or the undrawn position to the fully drawn position or the partially drawn position.

As further shown in FIG. 4, the valence 406 may be positioned at an upper portion of the shade 108. The valence 406 may be configured to cover the alternate bracket 102, the telescoping rod 104, and the motor 106 when the shade 108 is installed. The valence 406 may conceal structural and mechanical components from view, providing a finished aesthetic appearance. In a method of installing a modular window covering system, coupling the valence 406 to the alternate bracket 102, the telescoping rod 104, and the motor 106.

The valence 406 may be reversibly coupled to the alternate bracket 102. In some cases, the valence 406 may be reversibly coupled to the alternate bracket 102 via one or more magnets disposed within the valence 406. The one or more magnets disposed within the valence 406 may be neodymium magnets. Alternatively, the valence 406 may reversibly couple to the alternate bracket 102 via hook and loop fasteners or snap buttons. The reversible coupling of the valence 406 to the alternate bracket 102 may allow the valence 406 to be removed and replaced as desired.

The one or more textile fabrics 408 may form a main body of the shade 108. The one or more textile fabrics 408 may be comprised of natural fabrics including bamboo or other woven woods, cotton, linen, and silk. The one or more textile fabrics 408 may be comprised of synthetic fabrics including acrylic, nylon, and polyester. However, the one or more textile fabrics 408 may be comprised of any suitable fabric alternative. The shade 108 comprising the one or more textile fabrics 408 may be interchangeable without removal of the alternate bracket 102. In some cases, the shade 108 may be interchangeable without removal of the motor 106 or the telescoping rod 104.

The shade bottom 410 may be positioned at a lower edge of the shade 108. The shade bottom 410 may be defined by excess fabric from the one or more textile fabrics 408 folded upon itself to form an internal chamber. In some cases, hook and loop fasteners may be disposed within the internal chamber to allow the excess fabric to be secured. In some cases, a weight bar may be disposed within the internal chamber to facilitate the shade 108 from transposing between the fully drawn position, the partially drawn position, and the undrawn position. The weight bar may provide stability to the shade 108 and may assist in maintaining a flat appearance of the shade 108 when in the fully drawn position.

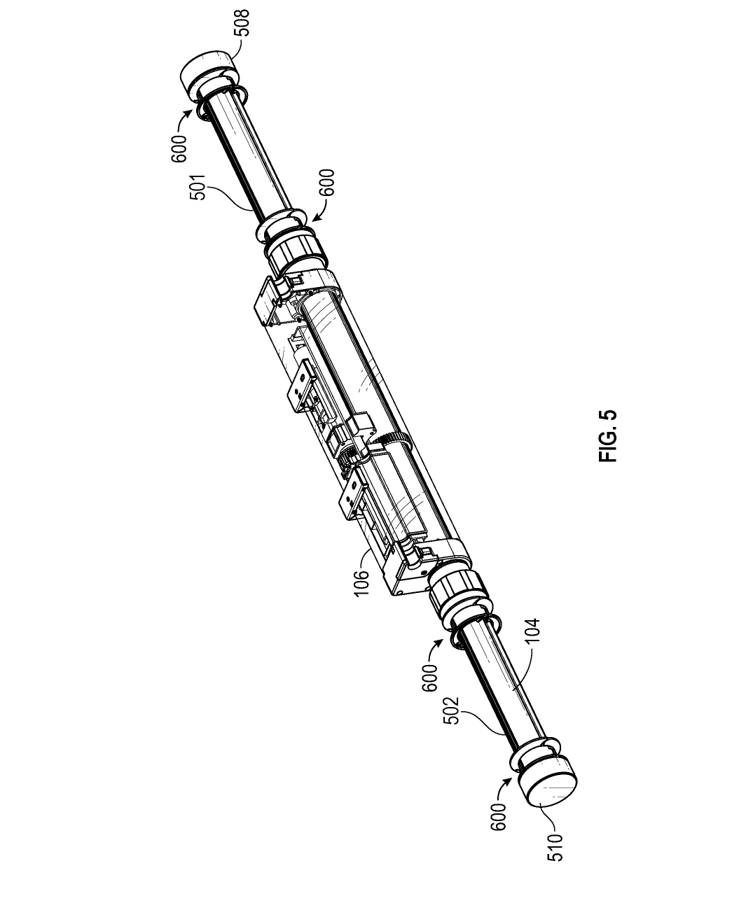

Referring to FIG. 5, an alternate configuration of the telescoping rod 104 and the motor 106 assembly is illustrated. In such an alternate configuration, the telescoping rod 104 may comprise a right arm 501 and a left arm 502. The right arm 501 and the left arm 502 may be extendable to adjust a length of the telescoping rod 104. The arms may extend symmetrically on each side of the motor 106. In cases where off-center mounting is desired, the bracket may be mounted slightly off-center if needed, and the motor or console assembly may be slid along the bracket rail after installation to center the system over the window opening.

The motor 106 may be positioned centrally along the telescoping rod 104 and may be coupled to the telescoping rod 104. The motor 106 may be configured to impart rotational motion upon the telescoping rod 104 to facilitate raising and lowering of the shade 108. The motor 106 may house a drive mechanism for operating the alternate modular shade system 100A or the modular shade system 100B. Internal components visible within the motor 106 housing may include electrical and mechanical components that drive the rotation of the telescoping rod 104 and control movement of the strip spool 600.

With continued reference to FIG. 5, the telescoping rod 104 may comprise an first end 508 disposed at a terminal end of the right arm 501. The telescoping rod 104 may further comprise an second end 510 disposed at an opposite terminal end of the left arm 502. The first end 508 and the second end 510 may be configured to interface with window frames or mounting brackets to secure the telescoping rod 104 in position during installation. The first end 508 and the second end 510 may provide abutment surfaces that contact the window frame to hold the telescoping rod 104 in a fixed horizontal position.

As further shown in FIG. 5, a plurality of strip spools 600 may be disposed along the telescoping rod 104. The strip spools 600 may be distributed at intervals along the telescoping rod 104 to provide even support across a width of the shade 108. The strip spools 600 may be separated by the right arm 501 and the left arm 502. Each strip spool 600 may be configured to interface with a shade strip 405 extending to the shade 108 to facilitate raising and lowering of the shade 108. In some cases, the shade strip 405 may attach to a first horizontal structural rod positioned above a bottom weighted bar of the shade 108. The distribution of the strip spools 600 along the telescoping rod 104 may provide multiple attachment points for the shade strip 405, which may distribute the load of the shade 108 across the width of the telescoping rod 104 and may provide uniform raising and lowering of the shade 108 during operation.

The strip spool 600 arrangement may correspond to the discrete configurations of the telescoping rod 104. In a collapsed configuration of the telescoping rod 104, a single strip spool 600 may be disposed on each side of the motor 106, with end caps positioned immediately adjacent to the respective spool. In a fully extended configuration of the telescoping rod 104, two strip spools 600 may be disposed on each side of the motor 106, positioned at the furthest ends of the expanded rod. In the fully extended configuration, the two strip spools 600 on each side may be fixed relative to one another by a connector element, such as a rigid connecting rod, that maintains their spacing and alignment.

The configuration of the telescoping rod 104 illustrated in FIG. 5 may provide a simplified adjustment mechanism compared to the configuration comprising the first left arm 302, the first right arm 301, the second left arm 304, the second right arm 303, the third left arm 306, and the third right arm 305. To illustrate, the right arm 501 and the left arm 502 configuration may reduce overall complexity and may improve a customer experience by simplifying the measurement and adjustment process during installation. The telescoping rod 104 may operate in discrete collapsed or fully extended configurations with symmetric arm extension.

The discrete rod and spool configurations may enable standardized lift-strip positioning across different window sizes. In narrower configurations corresponding to the collapsed rod, the shade 108 may use two lift strips, each positioned at a fixed, equal distance from a center of the fabric. In wider configurations corresponding to the fully extended rod, the shade 108 may use four lift strips. The four lift strips may include an inner pair located at the same positions as the two-strip configuration and an outer pair located at additional fixed positions symmetric about the centerline. Because these positions are standardized and tied to the rod configuration rather than absolute fabric width, fabric fabrication may not require custom calculation or alignment of lift-strip spacing on a per-window basis.

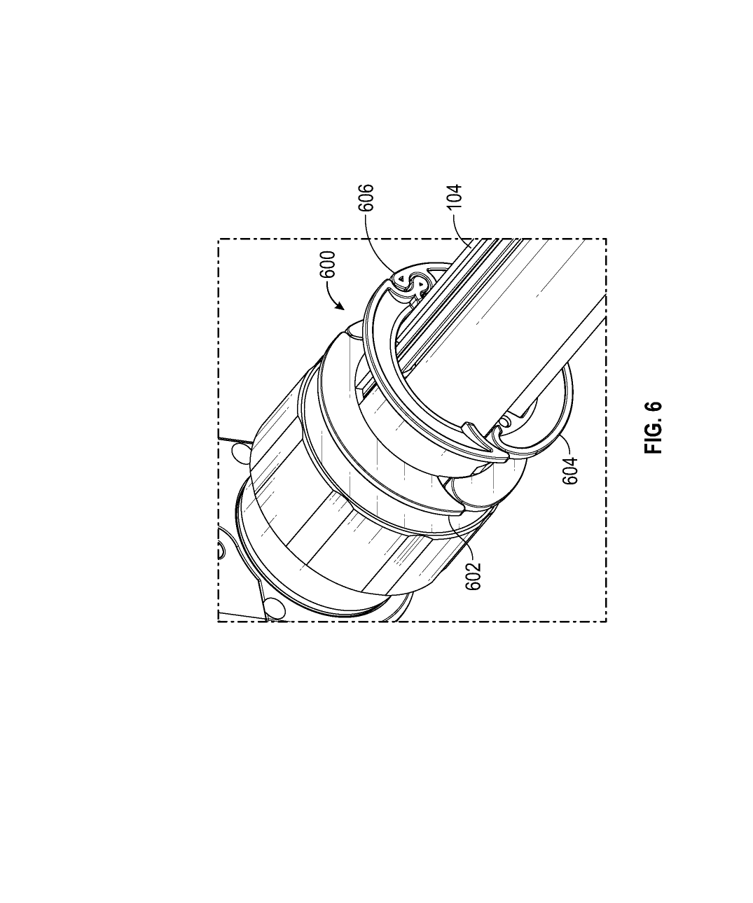

Referring to FIG. 6, the strip spool 600 is illustrated in greater detail. The strip spool 600 may be shown in relation to the telescoping rod 104. Each strip spool 600 may comprise an insertion clip 602 and a static clip 604. The insertion clip 602 and the static clip 604 may be connected via a clip joint 606. The clip joint 606 may provide a structural connection between the insertion clip 602 and the static clip 604, enabling the two clips to function together as a unified assembly for securing the shade strip 405 to the telescoping rod 104.

The strip spool 600 may be configured to interface with the telescoping rod 104, facilitating the winding and unwinding of the shade strip 405 during operation of the alternate modular shade system 100A or the modular shade system 100B. The insertion clip 602 may provide a mechanism for securing the shade strip 405 to the telescoping rod 104. The static clip 604 may remain in a fixed position relative to the strip spool 600 assembly. Alternatively, the shade strips 405 may attach to the strip spools 600 via hook-and-loop fasteners, magnetic attachments, snap-fit systems, track/channel systems, or any other system or attachment method that will allow the shade strips 405 to be wound around the strip spools 600.

With continued reference to FIG. 6, the insertion clip 602 and the static clip 604 may be configured such that the insertion clip 602 exhibits a force toward the telescoping rod 104 to pinch the shade strip 405 in place. The interlocking configuration of the insertion clip 602 and the static clip 604 may cause the insertion clip 602 to exhibit the force toward the telescoping rod 104. This force may secure the shade strip 405 between the insertion clip 602 and the telescoping rod 104, preventing the shade strip 405 from slipping or becoming dislodged during operation of the shade 108.

The telescoping rod 104 may extend through the strip spool 600 assembly, providing a rotational axis about which the strip spool 600 operates during shade positioning. As the motor 106 imparts rotational motion upon the telescoping rod 104, the strip spool 600 may rotate with the telescoping rod 104, causing the shade strip 405 to wind or unwind about the strip spool 600. The winding and unwinding of the shade strip 405 may facilitate raising and lowering of the shade 108 between the fully drawn position, the partially drawn position, and the undrawn position.

In a method of installing a modular window covering system, interfacing a plurality of strip spools 600 disposed along the telescoping rod 104 with the shade strips 405 extending to the shade 108 may facilitate raising and lowering of the shade 108. Interfacing the plurality of strip spools 600 may comprise positioning the shade strips 405 such that the insertion clip 602 exhibits a force toward the telescoping rod 104 to pinch each shade strip 405 in place. The positioning of the shade strips 405 within the strip spools 600 may secure the shade strips 405 for operation while allowing said strips 405 to be removed and replaced if desired.

The clip joint 606 may connect the insertion clip 602 and the static clip 604, enabling the structural relationship between the insertion clip 602 and the static clip 604 that produces the pinching force. The configuration of the clip joint 606 may allow the insertion clip 602 to pivot or flex relative to the static clip 604, generating the force that secures the shade strip 405 against the telescoping rod 104. The strip spool 600 assembly comprising the insertion clip 602, the static clip 604, and the clip joint 606 may provide a secure yet reversible attachment mechanism for the shade strip 405.

The motor may be transitioned between an operational state and a non-operational state. While in the operational state, the motor may translate energy derived from a battery into rotational movement of a rotating wheel, resulting in mechanical actuation of the telescoping rod. While in the non-operational state, the motor may not receive energy from the battery, preventing the motor from mechanically actuating the telescoping rod.

The motor may be toggled between the operational state and the non-operational state via user interaction with the motor or an external remote. A user may depress a mechanical actuation activator upon the external remote to activate the battery. Upon activation of the battery, energy may be delivered to the motor, transitioning the motor from the non-operational state to the operational state. The user may depress the mechanical actuation activator a second time to deactivate the battery, which may prevent the motor from receiving energy and may transition the motor from the operational state to the non-operational state.

The modular shade system may pair with an external smart home ecosystem to enable remote control of the system. In some cases, the external smart home ecosystem may be Apple HomeKit, Amazon Alexa, or Google Home. The external smart home ecosystem may control the raising and lowering of the shade. Through integration with the external smart home ecosystem, a user may operate the modular shade system via voice commands or through a software application associated with the external smart home ecosystem. The integration with the external smart home ecosystem may enable programmable schedules for raising and lowering the shade, which may enhance energy efficiency within a dwelling by automating shade positioning based on time of day or environmental conditions.

A number of implementations have been described. Nevertheless, it will be understood that various modifications may be made without departing from the spirit and scope of the disclosure. Accordingly, other implementations are within the scope of the following claims.

What is claimed is:

1. A modular window covering system, comprising:
a bracket configured to be mounted to at least one of a wall, a ceiling, and an interior surface of a window frame, the bracket comprising a plurality of mounting apertures;
a motor reversibly coupled to the bracket;
a telescoping rod reversibly coupled to the motor, the telescoping rod comprising a plurality of arms configured to extend and retract to adjust a length of the telescoping rod;
one or more strip spools disposed along the telescoping rod; and
a shade including one or more shade strips,
wherein each of the one or more strip spools interfaces with at least one of the one or more shade strips to facilitate raising and lowering of the shade.

2. The modular window covering system of claim 1, wherein each of the one or more strip spools comprises an insertion clip and a static clip connected via a clip joint.

3. The modular window covering system of claim 2, wherein the insertion clip and the static clip are configured such that the insertion clip exhibits a force toward the telescoping rod to pinch at least one of the one or more shade strips in place.

4. The modular window covering system of claim 1, wherein the bracket comprises:
a top mounting surface;
a side mounting surface extending from the top mounting surface; and
a plurality of motor mounting points disposed at each end of the bracket.

5. The modular window covering system of claim 4, wherein the motor mounting points are configured to facilitate coupling of the motor to the bracket.

6. The modular window covering system of claim 1, wherein the plurality of arms comprises:
a right arm and a left arm, wherein the right arm and the left arm are extendable to adjust the length of the telescoping rod.

7. The modular window covering system of claim 6, wherein the telescoping rod further comprises a first end disposed on the right arm and a second end disposed on the left arm, the first end and the second end configured to be positioned within a window frame with clearance on either side.

8. The modular window covering system of claim 1, wherein the shade further comprises:
a valence configured to cover the bracket, the telescoping rod, and the motor when the shade is installed; and
a shade bottom defined by excess fabric folded upon itself to form an internal chamber.

9. The modular window covering system of claim 8, wherein the valence is reversibly coupled to the bracket via one or more magnets disposed within the valence.

10. The modular window covering system of claim 1, wherein the motor is configured to impart rotational motion upon the telescoping rod about a longitudinal axis of the telescoping rod to transition the shade between a fully drawn position, a partially drawn position, and an undrawn position.

11. A modular window covering system, comprising:
a bracket comprising a top mounting surface and a side mounting surface, the bracket further comprising a plurality of mounting apertures disposed upon at least one of the top mounting surface and the side mounting surface;
a telescoping rod coupled to the bracket, the telescoping rod comprising a first arm and a second arm, wherein the first arm and the second arm are extendable to adjust a length of the telescoping rod;
a motor coupled to the telescoping rod and configured to impart rotational motion upon the telescoping rod; and
a shade reversibly coupled to the telescoping rod, the shade being interchangeable without removal of the bracket.

12. The modular window covering system of claim 11, further comprising a plurality of strip spools disposed along the telescoping rod, each of the plurality of strip spools configured to interface with a shade strip extending to the shade.

13. The modular window covering system of claim 12, wherein each of the plurality of strip spools comprises an insertion clip and a static clip connected via a clip joint, the insertion clip and the static clip configured such that the insertion clip exhibits a force toward the telescoping rod to pinch the shade strip in place.

14. The modular window covering system of claim 11, wherein the bracket further comprises a plurality of motor mounting points disposed at each end of the bracket, the motor mounting points configured to facilitate coupling of the motor to the bracket.

15. The modular window covering system of claim 11, wherein the shade comprises a valence configured to cover the bracket, the telescoping rod, and the motor when the shade is installed, the valence reversibly coupled to the bracket.

16. A method of installing a modular window covering system, the method comprising:
mounting a bracket to at least one of a wall, a ceiling, and an interior surface of a window frame via a plurality of mounting apertures disposed on the bracket;
coupling a motor to the bracket;
coupling a telescoping rod to the motor, the telescoping rod comprising a plurality of arms;
adjusting a length of the telescoping rod by extending or retracting at least one of the plurality of arms until the telescoping rod is sized to fit within a window opening with clearance on either side; and
reversibly coupling a shade to the telescoping rod, wherein the shade comprises one or more textile fabrics that are interchangeable without removal of the bracket.

17. The method of claim 16, wherein reversibly coupling the shade to the telescoping rod comprises:
interfacing a plurality of strip spools disposed along the telescoping rod with a plurality of shade strips affixed to the shade to facilitate raising and lowering of the shade.

18. The method of claim 17, wherein each of the plurality of strip spools comprises an insertion clip and a static clip connected via a clip joint, and wherein interfacing the plurality of strip spools comprises positioning at least one of the plurality of strips such that the insertion clip exhibits a force toward the telescoping rod to pinch the at least one of the plurality of shade strips in place.

19. The method of claim 16, further comprising coupling a valence to the bracket to cover the bracket, the telescoping rod, and the motor, wherein the valence is reversibly coupled to the bracket via one or more magnets disposed within the valence.
